(19) United States
(12) Patent Application Publication
(10) Pub. No.: US 2024/0161440 A1
(43) Pub. Date: May 16, 2024

(54) SYSTEMS AND METHODS FOR IMAGE ALIGNMENT AND AUGMENTATION

(71) Applicant: Shanghai United Imaging Intelligence Co., Ltd., Shanghai (CN)

(72) Inventors: Meng Zheng, Cambridge, MA (US); Yuchun Liu, Shanghai (CN); Fan Yang, Shanghai (CN); Srikrishna Karanam, Bangalore (IN); Ziyan Wu, Lexington, MA (US); Terrence Chen, Lexington, MA (US)

(73) Assignee: Shanghai United Imaging Intelligence Co., Ltd., Shanghai (CN)

(21) Appl. No.: 17/988,328

(22) Filed: Nov. 16, 2022

(51) Int. Cl. G06V 10/24; G06T 7/80; G06V 10/75; G06V 10/82

(52) U.S. Cl. CPC G06V 10/24; G06T 7/80; G06V 10/751; G06V 10/82; G06T 2207/10024; G06T 2207/20081

(57) ABSTRACT

Images captured by different image capturing devices may have different fields of views and/or resolutions. One or more of these images may be aligned based on an image template, and additional details for the adapted images may be predicted using a machine-learned data recovery model and added to the adapted images such that the images may have the same field of view or the same resolution.

### BACKGROUND

Images captured by different image capturing devices installed in the same environment may have different fields of view towards the environment and/or different resolutions. To utilize information contained in these images for a data processing task associated with the environment, the images may need to be aligned and/or augmented such that they may have the same field of view, same resolution, or a pixel-level correspondence. Conventional methods for accomplishing such a goal may crop the image(s) that have a larger field of view to fit the images with a smaller field of view, resulting (e.g., in at least some cases) in the output image(s) having a resolution equal to the minimum resolution of the input images. Accordingly, systems and methods capable of automatically aligning and/or augmenting cross-modality images so as to accomplish a large FOV and/or a high resolution may be desirable.

### SUMMARY

Described herein are systems, methods, and instrumentalities associated with automatic image alignment and augmentation. An apparatus configured to perform these tasks may include at least one processor configured to obtain images captured by respective image capturing devices, and adapt one or more of the images based on an image template. The images obtained by the processor may differ from each other with respect to at least one of a field of view (FOV) or a resolution, and the adaption conducted based on the image template may align the one or more of the images with respect to at least one of a size or an aspect ratio of the images (e.g., the one or more images may be adapted to have the same size or aspect ratio as the image template). The at least one processor may be further configured to determine additional details for the one or more adapted images based on a machine-learned (ML) data recovery model, and supplement the one or more adapted images with the additional details such that the one or more adapted images may have the same field of view or the same resolution.

In examples, the images obtained by the apparatus may include a color image captured by a color image sensor, a depth image captured by a depth sensor, and/or one or more medical scan images captured by respective medical imaging devices. The images may be captured at various (e.g., different) times and/or may have different fields of views (e.g., which may partially overlap). In examples, the image template used to align the images may be pre-defined or determined based on the images obtained by the apparatus. The parametric models may be determined based on respective intrinsic or extrinsic parameters of the image capturing devices, and may include respective projection matrices associated with the image capturing devices. The projection matrices may be used (e.g., during the image adaptation procedure) to project the images onto the image template.

In examples, the ML data recovery model may be implemented using at least one convolutional neural network (CNN) and may be trained on multiple sets of images, where each set of the multiple sets of images may include at least a first image captured by a first image capturing device and a second image captured by a second image capturing device. The first and the second images may be aligned to conform with a training image template and, during the training of the ML data recovery model (e.g., the neural network), the ML data recovery model may be configured to predict missing details for the first image based on the first image and the second image.

### BRIEF DESCRIPTION OF THE DRAWINGS

A more detailed understanding of the examples disclosed herein may be had from the following description, given by way of example in conjunction with the accompanying drawing.

FIG. 1 is a diagram illustrating an example of an environment in which the techniques disclosed herein may be implemented.

FIG. 2 is a diagram illustrating example techniques for aligning and augmenting cross-modality images, in accordance with one or more embodiments of the present disclosure.

FIG. 3 is a diagram illustrating an example of image alignment, in accordance with one or more embodiments of the present disclosure.

FIG. 4 is a diagram illustrating an example of predicting missing details of an image, in accordance with one or more embodiments of the present disclosure.

FIG. 5 is a flow diagram illustrating example operations that may be associated with training a neural network to perform the tasks described in accordance with one or more embodiments of the present disclosure.

FIG. 6 is a flow diagram illustrating example operations that may be associated with aligning and augmenting cross-modality images, in accordance with one or more embodiments of the present disclosure.

FIG. 7 is a block diagram illustrating example components of an apparatus that may be configured to perform the tasks described in accordance with one or more embodiments of the present disclosure.

### DETAILED DESCRIPTION

The present disclosure is illustrated by way of example, and not by way of limitation, in the figures of the accompanying drawings. A detailed description of illustrative embodiments will now be described with reference to the various figures. Although this description provides detailed examples of possible implementations, it should be noted that the details are intended to be illustrative and in no way limit the scope of the application.

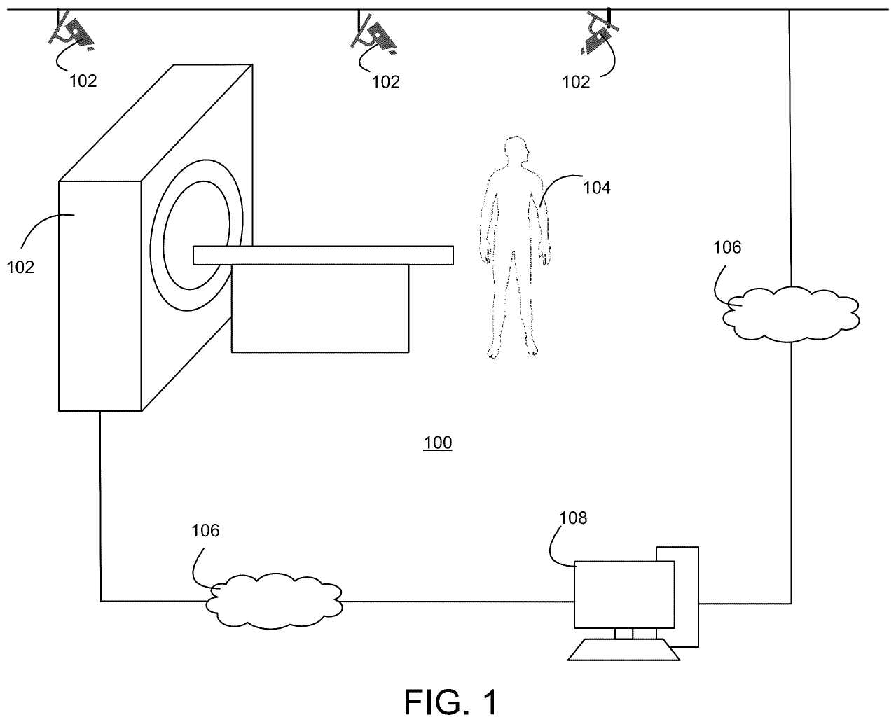

FIG. 1 illustrates an example environment 100 in which the techniques disclosed herein may be implemented. Environment 100 may be shown in FIG. 1 as a medical environment (e.g., part of a medical scan room for magnetic resonance imaging (MRI), X-ray, Computed Tomography (CT), etc., or an operating room), but those skilled in the art will appreciate that the techniques disclosed herein may also be applicable to other types of environments including, for example, a gaming environment, a rehabilitation facility, etc. As shown in FIG. 1, environment 100 may be equipped with one or more image capturing devices 102 that may be installed at different locations of the environment and configured to capture images (e.g., including videos) of the environment (e.g., including a patient 104 and/or a medical procedure being performed in environment). The image capturing devices 102 may include one or more sensors such as one or more color image sensors (e.g., color cameras), one or more depth sensors, one or more thermal sensors (e.g., infrared (FIR) or near-infrared (NIR) sensors), one or more radar sensors, one or more medical imaging devices (e.g., one or more CT, MRI, or X-ray scanners), etc. Depending on the types of image capturing devices installed in the environment 100, the images described herein may include, for example, one or more color images captured by the color image sensor(s), one or more depth images captured by the depth sensor(s), one or more thermal images captured by the thermal sensor(s), one or more medical scan images captured by the medical scanner(s), etc. The images may be captured by the different devices described herein, at different times during a time period, and/or from different viewpoints (e.g., some of which may overlap). As such, the images may differ from each other with respect to at least one of a field of view (e.g., of the environment 100), a resolution, a size, or an aspect ratio (e.g., 4:3, 16:9, etc.). The image capturing devices 102 may be communicatively coupled (e.g., via a communication network 106) to a processing device 108 (e.g., computing apparatus) and/or other devices in the environment 100, and may be configured to transmit images captured by the image capturing devices 102 to the processing device 108 and/or the other devices. In examples, one or more of image capturing devices 102 may themselves be equipped with a processing or functional unit (e.g., one or more processors) that may be configured to process the images captured by the image capturing devices 102.

Since the images captured by the image capturing devices 102 may differ from each other with respect to a field of view (FOV), resolution, size, and/or aspect ratio, the processing device 108 (or a processing unit of one of the image capturing devices 102) may be configured to adapt or adjust (e.g., align and/or augment) one or more of the images such that they may have the same FOV (e.g., in terms of the person(s) and object(s) covered in the FOV), resolution, size, aspect ratio, and/or the like (e.g., without having to crop images with a higher resolution to align with those having a lower resolution or a smaller FOV). The adapted or adjusted images may be used to facilitate various operations or tasks in the environment 100. These operations or tasks may include, for example, automating a medical procedure being performed in the environment 100 by recognizing, based on the adapted or adjusted images, person(s) (e.g., the patient 104) and/or device(s) (e.g., a surgical robot) involved in the medical procedure and the respective locations of the person(s) and/or device(s), such that navigations instructions may be automatically generated to move one or more of the device(s) towards the person(s) (e.g., towards the patient 104). As another example, the adjusted images may be used to reconstruct surface (e.g., a 3D mesh) and/or anatomical models (e.g., for an organ of the patient) for the patient, which may then be used for patient positioning, image overlay, image analysis, and/or other medical procedures or applications.

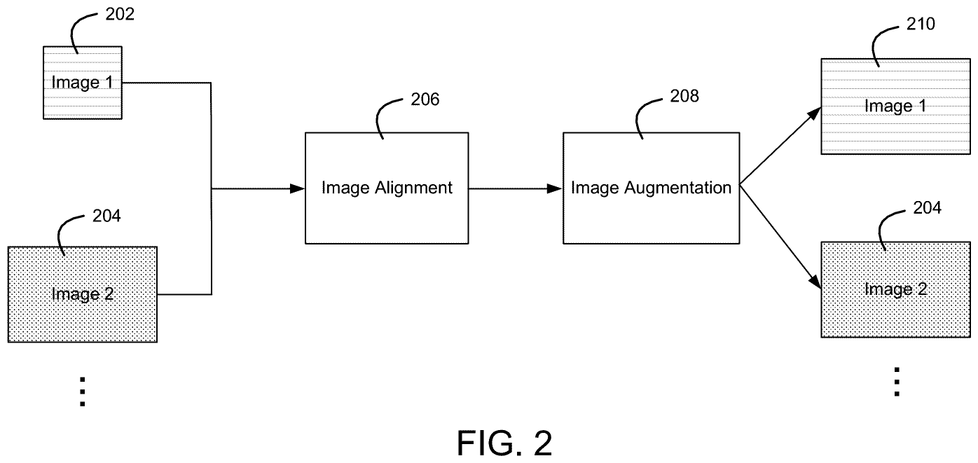

FIG. 2 illustrates an example of aligning and/or augmenting cross-modality images according to one or more embodiments of the present disclosure. As shown, a plurality of images captured by respective image capturing devices (e.g., such as devices 102 of FIG. 1) may be obtained. The images may include, for example, a first image 202 captured by a color image sensor and a second image 204 captured by a depth sensor, and the images may differ from each other with respect to at least one of a field of view (FOV) (e.g., a size of the FOV) or a resolution. For instance, the first image 202 may be associated with a smaller FOV of an environment (e.g., the environment 100 of FIG. 1) and a lower resolution, and the second image 204 may be associated with a larger FOV of the environment and a higher resolution (e.g., the respective FOVs of the first and second images may be different, but may partially overlap). To adapt the images such that they all have the same FOV and/or resolution, the images may be aligned (e.g., through an image alignment procedure 206) in accordance with an image template that may be pre-defined or determined, for example, based on the obtained images (e.g., the template may be determining based on the image that has the largest field of view). The image template may have a certain size and/or aspect ratio (e.g., width-to-height aspect ratio such as 4:3, 16:9, etc.), which may or may not be the same as some of the images (e.g., the template may have the same size or aspect ratio as the second image 204, but different from the first image 202). As such, one or more of the images (e.g., those not in conformance with the image template such as image 202) may be adjusted based on the image template so as to align the images with (e.g., fit the images to) the image template. The one or more adapted images may be further augmented (e.g., through an image augmentation procedure 208) with additional details that may be missing from the original images such that the resulting images may have the same FOV (e.g., in terms of the person(s) and object(s) covered in the FOV) and/or resolution as the rest of the images. The additional details may be determined, for example, using a machine-learned (ML) data recovery model trained for predicting the additional details based on information learned (e.g., during the training of the ML data recovery model) from other images that may have a larger FOV and/or a higher resolution.

It should be noted that all of the images captured by the image capturing devices may not need to be adapted (e.g., at 206) and/or augmented (e.g., at 208). If certain images (e.g., such as 204 of FIG. 2) already conform with the image template described herein and/or have the target FOV and/or resolution, the image alignment procedure 206 and/or image augmentation procedure 208 may be skipped for those images. It should also be noted that the terms “machine-learned model,” “machine learning model,” “artificial intelligence model,” and “neural network model” may be used interchangeably herein.

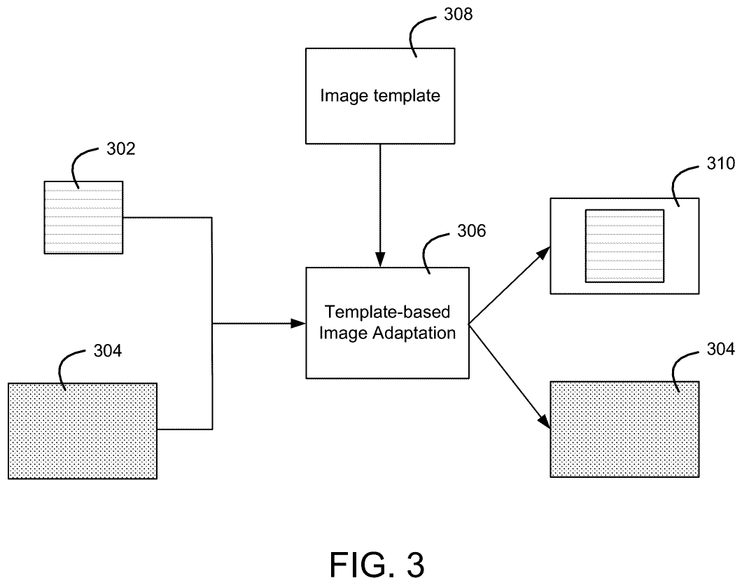

FIG. 3 illustrates an example of image alignment (e.g., the image alignment procedure 206 of FIG. 2) in accordance with one or more embodiments of the present disclosure. As shown, a first image 302 and a second image 304, which may be captured by respective image capturing devices, may have different sizes and/or aspect ratios. The images may be adapted at 306 based on an image template 308 such that the images may be aligned with each other and/or with the image template 308 (e.g., in terms of image size and/or aspect ratio). For example, if one or both of first image 302 and second image 304 have a different size or aspect ratio than the image template 308, the image(s) may be adapted (e.g., projected) at 306 to fit the image template 308 (e.g., to have the same size or aspect ratio as the image template), as shown by adapted image 310 (e.g., image 304 may remain the same if it is already in the same size and aspect ratio as the image template 308). The image template 308 may be determined based on the first image 302 or the second image 304 (e.g., if one of those images has the desired FOV, size, and/or aspect ratio), and the projection of the image(s) onto the image template 308 may be accomplished based on respective parametric models (e.g., parameterized mathematical relationship between a 3D point and its 2D projection) of the image capturing devices used to capture the first and second images. For example, the parametric models of the image capturing devices may be determined based on respective intrinsic or extrinsic parameters of the image capturing devices that may be acquired during installation of the image capturing devices, and the parametric models may be used to determine respective projection matrices for projecting the first image 302 and/or second image 304 onto the image template 308.

As illustrated by FIG. 3, the adapted image 310 (e.g., projected from image 302 based on image template 308) may lack details (e.g., shown by the blank parts of image 310) for conforming to a target FOV and/or resolution (e.g., the FOV and/or resolution of image 304). These details may be estimated using an ML data recovery model trained for predicting the details based on information learned (e.g., during the training of the ML data recovery model) from other images that may have the target FOV and/or resolution.

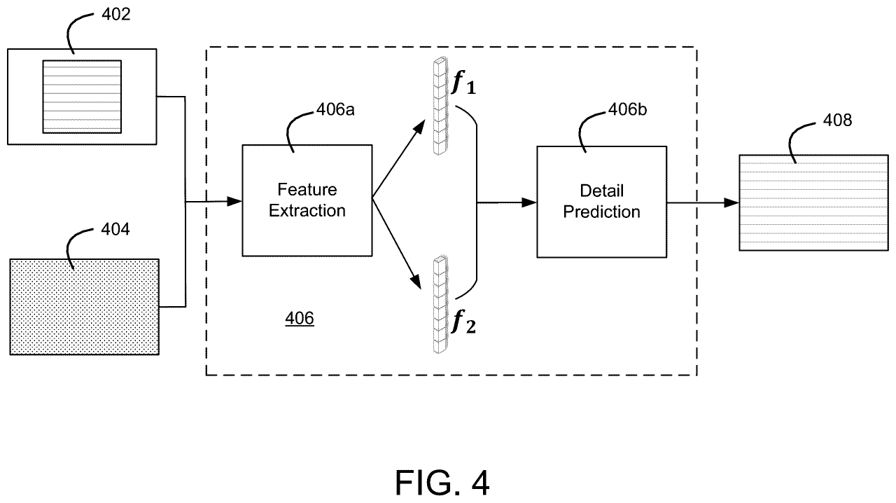

FIG. 4 illustrates techniques for predicting missing details of an image in accordance with one or more embodiments of the present disclosure. As shown in FIG. 4, an image 402 (e.g., the adapted image 310 of FIG. 3) captured by a first image capturing device may be missing details for achieving a target FOV and/or resolution. These details may be recovered (e.g., predicted or estimated) based on an image 404 and an ML model 406 (e.g., the data recovery model) trained for predicting the details. Image 404 may be captured by a different image capturing device, and may have a different FOV (e.g., a larger FOV) and/or a different resolution (e.g., a higher resolution) than image 402. For instance, image 402 may be a color image (e.g., a red-green-blue or RGB image) captured by a color image sensor (e.g., a camera) while image 404 may be a depth image captured by a depth image sensor. The ML model 406 may be implemented and/or learned using an artificial neural network, which may include one or more feature extraction module 406a and/or one or more detail prediction module 406b. The features extraction module(s) 406a may be configured to extract features f₁ and f₂ from images 402 and 404, respectively, and the detail prediction module(s) 406b may be configured to predict missing details for at least one of image 402 or image 404 based on the extract features f₁ and f₂, and supplement at least one of image 402 or image 404 with the additional details to obtain an augmented image 408. Even though the example shows only one augmented image 408 being generated for image 402, those skilled in the art will appreciate that similar augmentation may also be conducted for other input images (e.g., image 404) if those input images also lack details for achieving the target FOV and/or resolution.

Either or both of the feature extraction module(s) 406a and detail prediction module(s) 406b may be implemented using at least one convolutional neural network (CNN) that may comprise a plurality of layers such as one or more convolution layers, one or more pooling layers, and/or one or more fully connected layers. Each of the convolution layers may include a plurality of convolution kernels or filters configured to extract features from an input image through a series of convolution operations followed by batch normalization and/or linear (or non-linear) activation (e.g., rectified linear unit (ReLU) activation). The features extracted by the convolution layers may be down-sampled through the pooling layers and/or the fully connected layers to reduce the redundancy and/or dimension of the features, so as to obtain a representation of the down-sampled features (e.g., in the form of a feature vector or feature map). The neural network may further include one or more un-pooling layers and one or more transposed convolution layers that may be configured to up-sample and de-convolve the features extracted through the operations described above. As a result of the up-sampling and de-convolution, a dense feature representation (e.g., a dense feature map) of the input image(s) may be derived, which may then be used to estimate missing details for the input image(s).

The training of ML model 406 may be conducted using a training dataset comprising multiple sets of images. Each of the multiple sets of images may include training images (e.g., a first training image and a second training image) captured by respective image capturing devices, and the training images may be aligned to conform with a training image template (e.g., in terms of the sizes and/or aspect ratios of the training images). During a training iteration, ML model 406 may be configured to receive a set of aligned training images, extract features from the training images included in the set, and predict, based on the extracted features, missing details for one or more of the training images such that the resulting images may achieve a desired FOV and/or resolution. The prediction results may then be compared to ground truth (e.g., actual images having the desired FOV and/or resolution) to calculate a loss from the prediction, which may be used to adjust the parameters of the ML model (e.g., weights of the neural network used to implement the ML model), with an objective to minimize the loss.

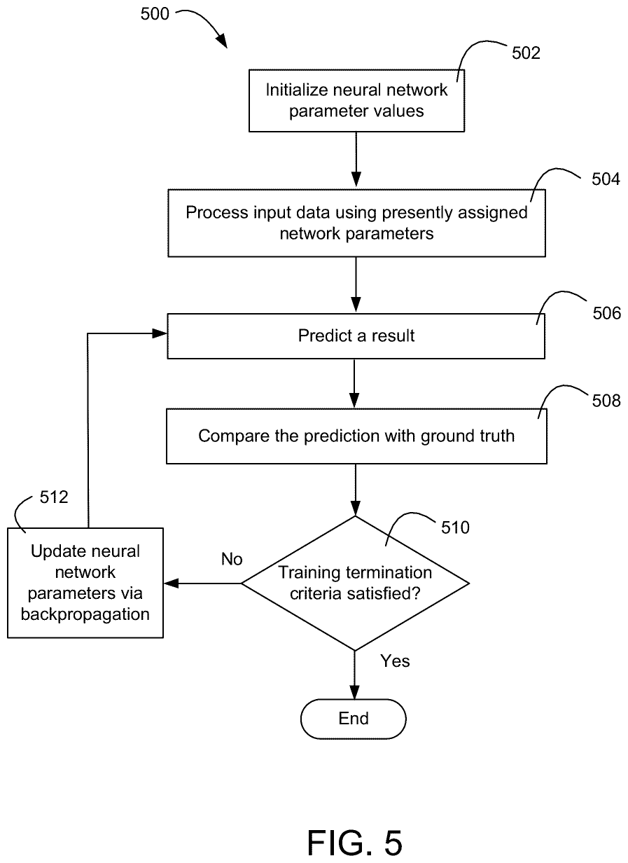

FIG. 5 illustrates example operations that may be associated with training a neural network (e.g., a neural network used to implement the ML data recovery model described herein) to perform one or more of the tasks described herein. As shown, the training operations may include initializing the operating parameters of the neural network (e.g., weights associated with various layers of the neural network) at 502, for example, by sampling from a probability distribution or by copying the parameters of another neural network having a similar structure. The training operations 500 may further include processing an input (e.g., a training image) using presently assigned parameters of the neural network at 504, and making a prediction for a desired result (e.g., an augmented image with additional details) at 506. The prediction result may be compared to a ground truth at 508 to determine a loss associated with the prediction, for example, based on a loss function such as mean squared errors between the prediction result and the ground truth, an L1 norm, an L2 norm, etc. At 510, the loss may be used to determine whether one or more training termination criteria are satisfied. For example, the training termination criteria may be determined to be satisfied if the loss is below a threshold value or if the change in the loss between two training iterations falls below a threshold value. If the determination at 510 is that the termination criteria are satisfied, the training may end; otherwise, the presently assigned network parameters may be adjusted at 512, for example, by backpropagating a gradient descent of the loss function through the network before the training returns to 506.

For simplicity of explanation, the training operations are depicted and described herein with a specific order. It should be appreciated, however, that the training operations may occur in various orders, concurrently, and/or with other operations not presented or described herein. Furthermore, it should be noted that not all operations that may be included in the training method are depicted and described herein, and not all illustrated operations are required to be performed.

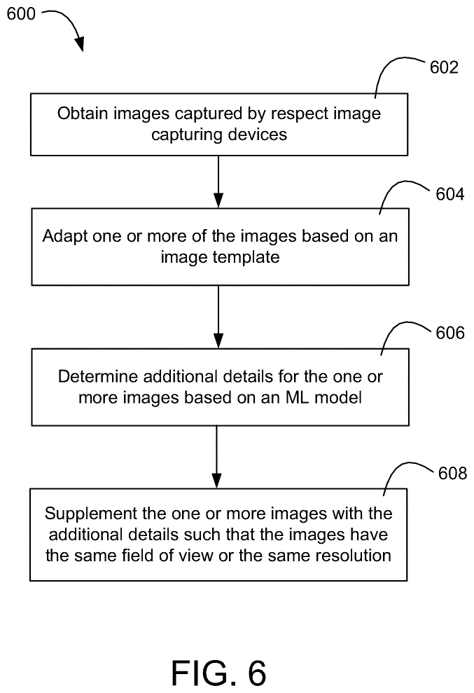

FIG. 6 illustrates example operations 600 that may be associated with aligning and augmenting one or more images to achieve a common FOV and/or resolution for the images. As shown, operations 600 may include obtaining images captured by respective image capturing devices at 602, where the images may differ from each other with respect to at least one of a FOV or a resolution. Operations 600 may further include adapting one or more of the images based on an image template at 604, and determining additional details for the one or more adapted images based on a machine-learned (ML) data recovery model 606. In examples, the adaptation at 604 may align the one or more images with respect to at least one of a size or an aspect ratio of the images (e.g., based on the size or aspect ratio of the image template), and the ML data recovery model used at 606 may be trained for predicting the additional details based on information learned (e.g., during the training of the ML data recovery model) from other images that may have the target FOV and/or resolution. Once determined, the additional details may be added to the one or more adapted images (e.g., the one or more adapted images may be supplemented with the details) at 608 such that all of the images obtained at 602 may have the same FOV (e.g., in terms of the person(s) and object(s) covered in the FOV) and/or resolution.

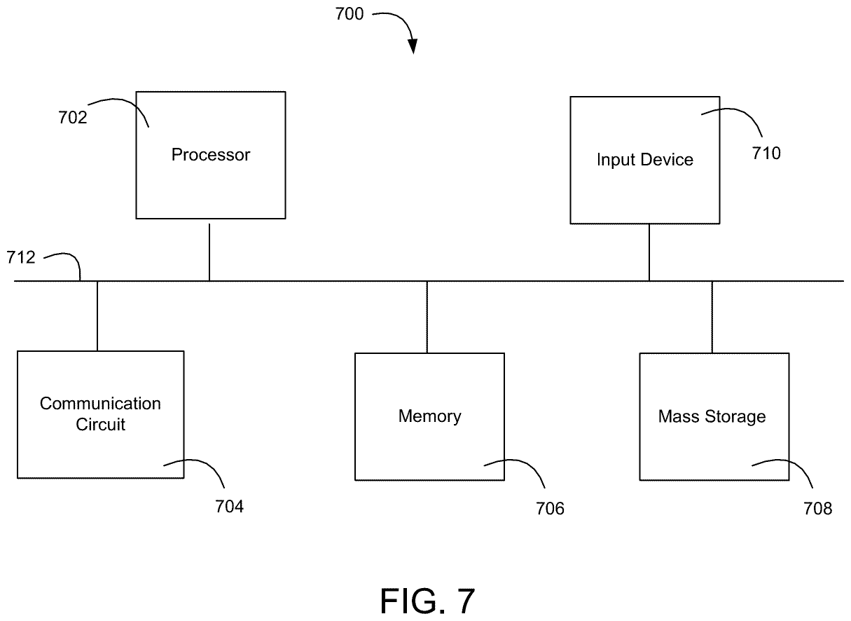

The systems, methods, and/or instrumentalities described herein may be implemented using one or more processors, one or more storage devices, and/or other suitable accessory devices such as display devices, communication devices, input/output devices, etc. FIG. 7 is a block diagram illustrating an example apparatus 700 that may be configured to perform the image alignment and/or augmentation tasks described herein. As shown, apparatus 700 may include a processor (e.g., one or more processors) 702, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 700 may further include a communication circuit 704, a memory 706, a mass storage device 708, an input device 710, and/or a communication link 712 (e.g., a communication bus) over which the one or more components shown in the figure may exchange information.

Communication circuit 704 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 706 may include a storage medium (e.g., a non-transitory storage medium) configured to store machine-readable instructions that, when executed, cause processor 702 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 708 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 702. Input device 710 may include a keyboard, a mouse, a voice-controlled input device, a touch sensitive input device (e.g., a touch screen), and/or the like for receiving user inputs to apparatus 700.

It should be noted that apparatus 700 may operate as a standalone device or may be connected (e.g., networked, or clustered) with other computation devices to perform the functions described herein. And even though only one instance of each component is shown in FIG. 7, a skilled person in the art will understand that apparatus 700 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus, comprising:
at least one processor configured to:
obtain images captured by respective image capturing devices, wherein the images differ from each other with respect to at least one of a field of view or a resolution;
adapt one or more of the images based on an image template;
determine additional details for the one or more adapted images based on a machine-learned (ML) data recovery model; and
supplement the one or more adapted images with the additional details such that the one or more adapted images have a same field of view or a same resolution.

2. The apparatus of claim 1, wherein the images obtained by the at least one processor include a color image captured by a color image sensor and a depth image captured by a depth sensor.

3. The apparatus of claim 1, wherein the images obtained by the at least one processor include a first medical scan image captured by a first medical imaging device and a second medical scan image captured by a second medical imaging device.

4. The apparatus of claim 1, wherein the images obtained by the at least one processor include at least two images captured at different times or having an overlapping field of view.

5. The apparatus of claim 1, wherein the at least one processor is configured to adapt the one or more of the images based on the image template such that the one or more of the images have a same size or a same aspect ratio as the image template.

6. The apparatus of claim 1, wherein the at least one processor is further configured to determine the image template based on the images obtained by the at least one processor.

7. The apparatus of claim 6, wherein the respective parametric models associated with the image capturing devices are determined based on respective intrinsic or extrinsic parameters of the image capturing devices.

8. The apparatus of claim 6, wherein the respective parametric models associated with the image capturing devices include respective projection matrices associated with the image capturing devices, and wherein the at least one processor being configured to adapt the one or more of the images based on the image template comprises the at least one processor being configured to project the one or more of the images onto the image template based on the respective projection matrices.

9. The apparatus of claim 1, wherein the ML data recovery model is trained on multiple sets of images, each set of the multiple sets of images including at least a first image captured by a first image capturing device and a second image captured by a second image capturing device, the first image and the second image conforming with a training image template, and wherein, during the training of the ML data recovery model, the ML data recovery model is configured to predict missing details for the first image based on the first image and the second image.

10. The apparatus of claim 9, wherein the ML data recovery model is implemented using at least one convolutional neural network.

11. A method of image processing, comprising:
obtaining images captured by respective image capturing devices, wherein the images differ from each other with respect to at least one of a field of view or a resolution;
adapting one or more of the images based on an image template;
determining additional details for the one or more adapted images based on a machine-learned (ML) data recovery model; and
supplementing the one or more adapted images with the additional details such that the one or more adapted images have a same field of view or a same resolution.

12. The method of claim 11, wherein the obtained images include a color image captured by a color image sensor and a depth image captured by a depth sensor.

13. The method of claim 11, wherein the obtained images include a first medical scan image captured by a first medical imaging device and a second medical scan image captured by a second medical imaging device.

14. The method of claim 11, wherein the obtained images include at least two images captured at different times or having an overlapping field of view.

15. The method of claim 11, the one or more of the images are adapted based on the image template such that the one or more of the images have a same size or a same aspect ratio as the image template.

16. The method of claim 11, further comprising determining the image template based on the images obtained by the at least one processor.

17. The method of claim 16, wherein the respective parametric models associated with the image capturing devices are determined based on respective intrinsic or extrinsic parameters of the image capturing devices.

18. The method of claim 16, wherein the respective parametric models associated with the image capturing devices include respective projection matrices associated with the image capturing devices, and wherein adapting the one or more of the images based on the image template comprises projecting the one or more of the images onto the image template based on the respective projection matrices.

19. The method of claim 11, wherein the ML data recovery model is trained on multiple sets of images, each set of the multiple sets of images including at least a first image captured by a first image capturing device and a second image captured by a second image capturing device, the first image and the second image conforming with a training image template, and wherein, during the training of the ML data recovery model, the ML data recovery model is configured to predict missing details for the first image based on the first image and the second image.

20. The method of claim 19, wherein the ML data recovery model is implemented using at least one convolutional neural network.
